(19) United States
(12) Patent Application Publication
(10) Pub. No.: US 2017/0186081 A1
(43) Pub. Date: Jun. 29, 2017

(54) CONNECTING LEASE SYNDICATORS AND FINANCIAL INSTITUTIONS IN AN ONLINE MARKETPLACE

(71) Applicant: Market Capex, LLC, Farmington, UT (US)

(72) Inventor: Nate Farnsworth, Farmington, UT (US)

(73) Assignee: Market Capex, LLC, Farmington, UT (US)

(21) Appl. No.: 15/393,242

(22) Filed: Dec. 28, 2016

Related U.S. Application Data
(60) Provisional application No. 62/271,846, filed on Dec. 28, 2015.

(51) Int. Cl. G06Q 30/06; G06Q 40/02; G06Q 20/10

(52) U.S. Cl. CPC G06Q 30/0645; G06Q 20/102; G06Q 40/02

(57) ABSTRACT

An apparatus, system, program product, and method are disclosed for connecting lase syndicators and financial institutions in an online marketplace. A method includes receiving a request for financing a leased product from a lease syndicator, electronically presenting the request for financing to one or more financial institutions, receiving an acceptance of the request for financing from a financial institution, and automatically preparing financing documents to complete the financing between the lease syndicator and the financial institution. One or more data fields of the financing documents are pre-populated with information associated with the lease syndicator, the financial institution, and the leased product.

### CROSS-REFERENCES TO RELATED APPLICATIONS

This application claims the benefit of U.S. Provisional Patent Application No. 62/271,846 entitled “CONNECTING LESSEES AND FINANCIAL INSTITUTIONS IN AN ONLINE MARKETPLACE” and filed on Dec. 28, 2015, for Nate Farnsworth, which is incorporated herein by reference.

### FIELD

This invention relates to facilitating network connections and more particularly relates to connecting lease syndicators and financial institutions in an online marketplace.

### BACKGROUND

Connecting lease syndicators and financial institutions willing to provide financing to the lease syndicators can be time consuming and expensive. Furthermore, there is no guarantee that all of the available financial institutions are being presented with a particular financing request, which may otherwise improve the competition, and the overall market, for lease financing.

### SUMMARY

A method includes receiving a request for financing a leased product from a lease syndicator, electronically presenting the request for financing to one or more financial institutions, receiving an acceptance of the request for financing from a financial institution, and automatically preparing financing documents to complete the financing between the lease syndicator and the financial institution. One or more data fields of the financing documents are pre-populated with information associated with the lease syndicator, the financial institution, and the leased product.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 depicts one embodiment of a schematic block diagram of a system for connecting lease syndicator and financial institutions in an online marketplace;

FIG. 2 depicts one embodiment of a schematic block diagram of a module for connecting lease syndicator and financial institutions in an online marketplace; and

FIG. 3 depicts one embodiment of a schematic flow chart diagram for connecting lease syndicator and financial institutions in an online marketplace.

### DETAILED DESCRIPTION

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures Like numbers may refer to like elements in the figures, including alternate embodiments of like elements.

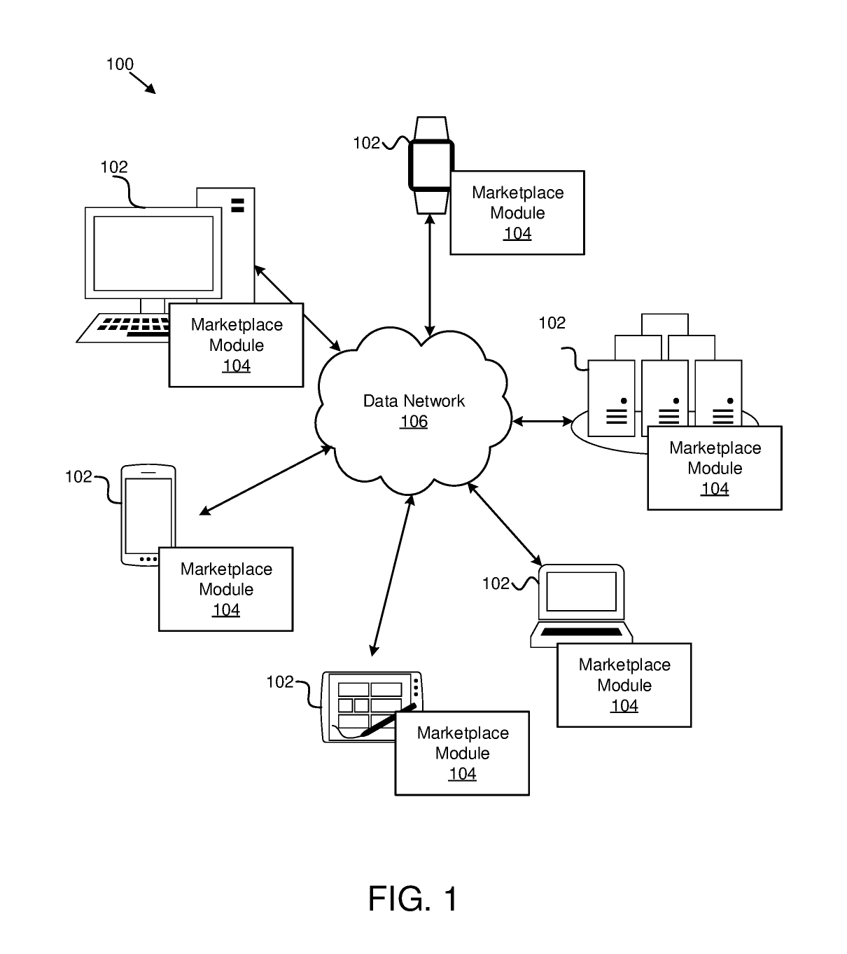

FIG. 1 depicts one embodiment of a system 100 for connecting lease syndicators and financial institutions in an online marketplace. In one embodiment, the system 100 includes information handling devices 102, marketplace modules 104, and data networks 106. In certain embodiments, even though a specific number information handling devices 102, marketplace modules 104, and data networks 106 are depicted in FIG. 1, one of skill in the art will recognize that any number of information handling devices 102, marketplace modules 104, and data networks 106 may be included in the system 100 for connecting buyers and sellers in an online marketplace.

In one embodiment, the information handling devices 102 include desktop computers, laptop computers, personal digital assistants (PDAs), tablet computers, smart phones, smart televisions (e.g., televisions connected to the Internet), set-top boxes, game consoles, or the like. In some embodiments, the information handling devices 102 include wearable devices, such as smart watches, fitness bands, optical head-mounted displays, or the like.

In certain embodiments, the information handling devices 102 include servers, blade servers, virtual servers, cloud servers, servers of a data center, network servers, remote servers, or the like. The servers may be configured as application servers, email servers, database servers, file servers, game servers, home servers, media servers, web servers, and/or the like. In certain embodiments, the servers are communicatively coupled to other information handling devices 102 via the data network 106 such that the information handling devices 102 may store and/or access data on the servers. For example, servers may store applications, files, programs, metadata, databases, registries, log files, or the like.

The information handling devices 102 may include various storage devices for storing files, such as text files, images, videos, source code, PDF files, music files, or the like. The storage devices may include memory such as flash storage media, hard disk drives, removable storage media, tape drives, solid-state storage media, read-only memory (“ROM”), random access memory (“RAM”), or the like. The information handling devices 102 may be installed with an operating system, such as Microsoft Windows®, Windows Server®, Apple OS X®, various Linux® distributions, Android®, iOS®, Windows Mobile®, or the like. Furthermore, the information handling devices 102 may include a file system that organizes, arranges, or otherwise manages storage and access of various files stored on the information handling devices 102.

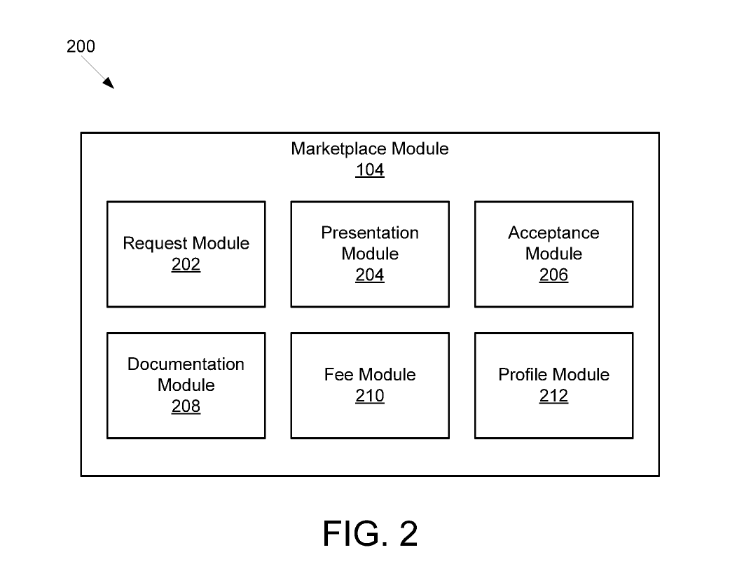

In one embodiment, the marketplace module 104 is configured to provide an online marketplace for connecting users, brokers, companies, organizations, financial institutions, or the like, seeking to lease products (“lease syndicators”) with financial institutions, or other parties, that can provide financing to the users seeking to lease products. The marketplace module 104 provides a user interface, e.g., a website or mobile application, for receiving requests for lease financing and presenting the requests to financial institutions that may be interested in providing an offer to provide the lease financing. The marketplace module 104 is described below in more detail with reference to FIG. 2.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

FIG. 2 depicts one embodiment of a module 200 for connecting lease syndicators and financial institutions in an online marketplace. In one embodiment, the module 200 includes an instance of a marketplace module 104. The marketplace module 104, in some embodiments, includes one or more of a request module 202, a presentation module 204, an acceptance module 206, a documentation module 208, a fee module 210, and a profile module 212, which are described in more detail below.

In one embodiment, the request module 202 receives a request for financing a leased product from a lease syndicator. The leased product may include vehicles, construction equipment, machinery, computing devices, office equipment, and/or the like. The leased product may be associated with a particular industry, such as construction, healthcare, technology, education, government, or the like. In one embodiment, the request module 202 receives the financing request for leased product from a lease syndicator via a website interface, a mobile application, or the like.

In one embodiment, the request includes images of the product to be leased, a description of the leased product, a description of how the product will be used, a lease price for the product, specifications of the leased product, and a history for the leased product.

In one embodiment, the presentation module 204 electronically presents the request for financing to one or more financial institutions. In one embodiment, the financial institutions have pre-registered to receive requests for financing. In certain embodiments, the financial institutions may include banks, venture capitalists, hedge fund managers, investment bankers, any combination of the foregoing, and/or the like.

In certain embodiments, the presentation module 204 electronically presents the request for financing to financial institutions using emails, push notifications, text messages, chat messages, automated voice calls, social media messages, banner-ads or other digital advertising, and/or the like. In various embodiments, the presentation module 204 determines an industry that the leased product is associated with and presents the financing request to financial institutions that are associated with the industry.

In one embodiment, the acceptance module 206 receives an acceptance of the request for financing from the financial institution. The acceptance module 206, for example, may receive a counter-offer as an acceptance, may receive a term sheet as acceptance, may receive a contract as acceptance, may receive a message that the request has been reviewed and accepted, and/or the like. In response to receiving the acceptance of the request, the acceptance module 206 may facilitate offers and counter-offers from both the lease syndicator and the financial institution that accepted the request.

In one embodiment, the documentation module 208 automatically prepares documents to complete the financing between the lease syndicator and the financial institution after a final contract, term sheet, or the like has been approved by all parties. The documentation module 208 may automatically pre-populate one or more data fields of financing documents with information associated with the lease syndicator, the financial institution, and/or the leased product. For example, the documentation module 208 may prepare a lease agreement between a lease syndicator and a financial institution in a PDF format and may pre-populate various data fields of the lease agreement with information associated with both parties e.g., as determined from user input, profile information (described below), or the like. In some embodiments, the financing documents may include digital copies of equipment titles, licenses, registrations, and/or the like.

In one embodiment, the fee module 210 determines a fee payment for each of the lease syndicators and the financial institutions in order to submit financing requests and/or receive requests for financing. In some embodiments, the fee module 210 does not require a fee from lease syndicators, while the financial institutions may be required to pay a fee to receive requests for financing. In such an embodiment, the fee module 210 prevents the financial institution from receiving requests for financing from the lease syndicator until the fee payment is paid in full.

The profile module 212, in one embodiment, generates a profile for a lease syndicator and/or a financial institution. The profile for a lease syndicator, for example, may include information and leasing preferences associated with the lease syndicator, which may be used to present one or more leasing offers from financial institutions to the lease syndicator. For example, the lease syndicator may prefer to only see financing offers that have a 5% or less interest rate, or financing offers that provide for 360 month terms, or the like.

Similarly, the profile for a financial institution may include preferences that specify that types of equipment that they will finance, a minimum credit score, a minimum or maximum amount, terms and rates offered, or the like.

In one embodiment, the profile for a lease syndicator may include a rating (e.g., a number of stars, a number on a scale of 1-10, or the like) for each leasing deal that the lease syndicator has completed in the past based on feedback received from the lease syndicator. The rating may be used to determine future financing offers to provide to the lease syndicator, to recommend certain financial institutions for financing, and/or the like. The rating may also be used to rank or weight financial institutions that offer financing to lease syndicators.

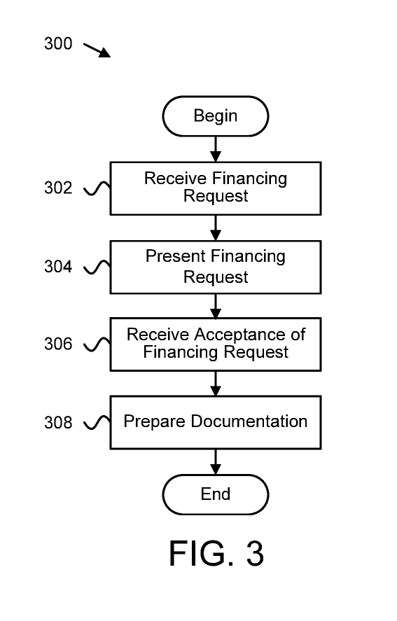

FIG. 3 depicts one embodiment of a method 300 for connecting lase syndicators and financial institutions in an online marketplace. In one embodiment, the method 300 begins, and a request module 202 receives 302 a request for financing a leased product from a lease syndicator. In some embodiments, a presentation module 204 electronically presents 304 the request for financing to one or more financial institutions. In a further embodiment, an acceptance module 206 receives 306 an acceptance of the request for financing from a financial institution. In one embodiment, a documentation module 208 automatically prepares 308 financing documents to complete the financing between the lease syndicator and the financial institution. In some embodiments, one or more data fields of the financing documents are pre-populated with information associated with the lease syndicator, the financial institution, and the leased product, and the method 300 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
receiving a request for financing a leased product from a lease syndicator;
electronically presenting the request for financing to one or more financial institutions;
receiving an acceptance of the request for financing from a financial institution; and
automatically preparing financing documents to complete the financing between the lease syndicator and the financial institution, wherein one or more data fields of the financing documents are pre-populated with information associated with the lease syndicator, the financial institution, and the leased product.

2. The method of claim 1, wherein the request for financing is electronically presented to the financial institution via one or more of a text message, an email, a chat message, a push notification, an automated voice message, and a social media post.

3. The method of claim 1, wherein the lease syndicator submits the request for financing on one or more of a website and a native mobile application.

4. The method of claim 1, wherein the request for financing comprises one or more of images of the leased product, a description of how the product will be used, a lease price for the product, specifications of the leased product, and a history of the leased product.

5. The method of claim 1, wherein the financing documents comprises one or more of equipment titles, licenses, and registrations.

6. The method of claim 1, further comprising electronically receiving a fee payment from the financial institution prior to presenting financing requests to the financial institution.

7. The method of claim 6, further comprising preventing the financial institution from receiving requests for financing from the lease syndicator until the fee payment is paid.

8. The method of claim 1, further comprising generating a profile for a lease syndicator, the profile comprising information and leasing preferences associated with the lease syndicator, wherein the information and leasing preferences are used to present one or more leasing offers from financial institutions to the lease syndicator.

9. The method of claim 8, wherein the profile further comprises a rating for each of one or more leasing deals that the lease syndicator has completed, the rating based on feedback received from the lease syndicator.

10. The method of claim 9, wherein the rating is used to determine one or more future financing offers to present to the lease syndicator.

11. The method of claim 1, further comprising determining an industry associated with the request for financing, the industry used to select a particular financial institution to present the financing request to.

12. An apparatus comprising:
a request module that receives a request for financing a lease product from a lease syndicator;
a presentation module that presents the request for financing to one or more financial institutions;
an acceptance module that receives an acceptance of the request for financing from a financial institution; and
a documentation module that automatically prepares financing documents to complete the financing between the lease syndicator and the financial institution, wherein one or more data fields of the financing documents are pre-populated with information associated with the lease syndicator, the financial institution, and the leased product.

13. A computer program product comprising a non-transitory computer readable storage medium storing computer usable program code executable to perform:
receiving a request for financing a leased product from a lease syndicator;
electronically presenting the request for financing to one or more financial institutions;
receiving an acceptance of the request for financing from a financial institution; and
automatically preparing financing documents to complete the financing between the lease syndicator and the financial institution, wherein one or more data fields of the financing documents are pre-populated with information associated with the lease syndicator, the financial institution, and the leased product.
